(19) United States
(12) Patent Application Publication
(10) Pub. No.: US 2004/0073696 A1
(43) Pub. Date: Apr. 15, 2004

(54) Image output apparatus having online help function and method of providing help function using the same

(75) Inventor: Hyuck Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/653,273

(22) Filed: Sep. 3, 2003

(30) Foreign Application Priority Data
Oct. 10, 2002 (KR) 2002-59771

(51) Int. Cl. G06F 15/16

(52) U.S. Cl. 709/232; 709/219

(57) ABSTRACT

An image output apparatus and method to download and output a user manual of an image forming apparatus in real-time via a network. The method includes receiving a request for a user manual corresponding to a predetermined operation function of the image output apparatus; creating product and function codes of the image output apparatus based on the request information related to the user manual; transmitting the created product and function codes to the server to provide the user manual via the network; and receiving user manual information corresponding to the transmitted product and function codes from the server and outputting the user manual information in a predetermined format.

### CROSS-REFERENCE TO RELATED APPLICATIONS

This application claims priority from Korean Patent Application No. 2002-59771, filed on Oct. 1, 2002, in the Korean Intellectual Property Office, the disclosure of which is incorporated herein in its entirety by reference.

### BACKGROUND OF THE INVENTION

1. Field of the Invention

The present invention relates to image output systems such as printers and copiers, and more particularly, to an image output apparatus and method of downloading and outputting a user manual of an image forming apparatus in real-time via a network.

2. Description of the Related Art

Generally, manufacturers who manufacture and provide various devices including electronic goods, provide buyers with user manuals including installation and operation methods, function descriptions, notices, etc., in a booklet form, along with their products, so that the buyers can correctly utilize the products.

However, there are many cases that the user manuals provided in paper form are lost. If the user manual is lost, the user can experience many inconveniences and difficulties when using the product. Further, if the user manual is lost, the user may have difficulty in finding information related to corrective maintenance such as telephone numbers of Service Centers. Furthermore, since the manufacturer should produce and supply paper versions of the user manuals to all buyers, the problem of cost increase exists.

Also, as more functions are added to electronic products, the more difficult it becomes for the user to search for his/her desired function in the paper version of the user manual.

### SUMMARY OF THE INVENTION

The present invention provides an image output apparatus and method of downloading and outputting a user manual of an image forming apparatus online via a network.

According to an aspect of the present invention, there is provided a method of providing a user manual, in an image output apparatus connected to a server to provide a user manual via a network, the method comprising: receiving a request for a user manual corresponding to a predetermined operation function of the image output apparatus; creating product and function codes of the image output apparatus based on the requested information for the user manual; transmitting the created product and function codes to the server to provide the user manual via the network; and receiving user manual information corresponding to the transmitted product and function codes from the server and outputting the user manual information in a predetermined format.

According to another aspect of the present invention, there is provided an image output apparatus connected with a server to provide a user manual via a network, the image output apparatus comprising: a memory which stores product and function codes of the image output apparatus; and a controller which receives a request of user manual information of a predetermined function, transmits to the server corresponding product and function codes stored in the memory, and receives user manual information corresponding to the product and function codes from the server so as to output the user manual information.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 shows a construction of a service system for providing “HELP”, according to an embodiment of the present invention;

FIG. 2 is a block diagram of an image output apparatus of FIG. 1;

FIG. 3 is a flow chart illustrating a method of providing “HELP”, through the image output apparatus, according to an embodiment of the present invention; and

FIG. 4 is a flow chart illustrating a method of providing “HELP”, through a server, according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

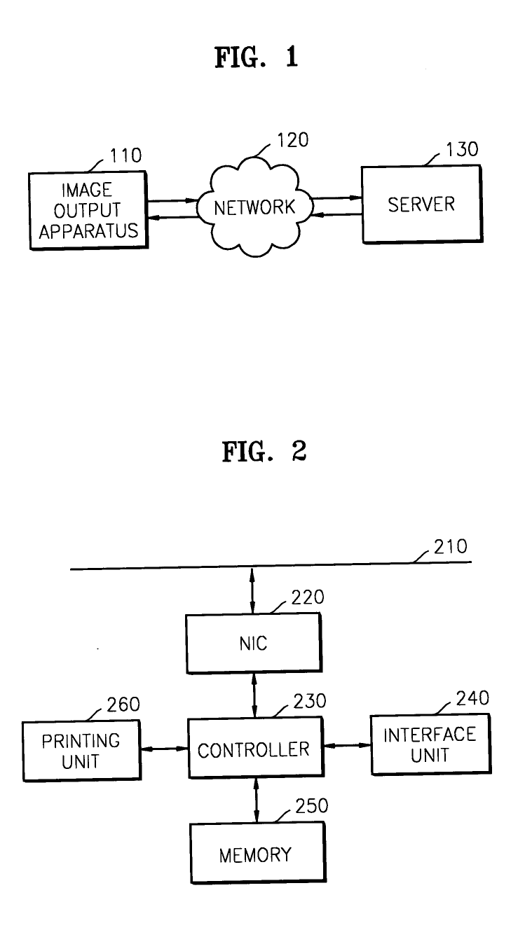

FIG. 1 shows a construction of a service system to provide “HELP”, according to a present invention.

In the system shown in FIG. 1, an image output apparatus 110 and a server 130 are interconnected via a network 120.

Referring to FIG. 1, if the image output apparatus 110 receives a request related to user manual information of a desired function from a user, the image output apparatus 110 requests product codes and function codes from the server 130 via the network 120 and then receives user manual information transmitted from the server 130 so as to output the user manual information.

The server 130 stores user manual information corresponding to respective apparatuses in its database, wherein the respective apparatuses are connected to the server 130. If a user requests user manual information of an apparatus, for example, the image output apparatus 110, being currently used by the user, the server 130 analyzes the corresponding product codes and function codes of the image output apparatus 110, and transmits contents corresponding to the desired function from the user manual information of the apparatus required by the user, to the image output apparatus 110 via the network 120.

FIG. 2 is a block diagram of the image output apparatus 110 of FIG. 1.

Referring to FIG. 2, memory 250 stores information related to various functions, a network address of the apparatus, and product information of an output data format supported by the apparatus. A NIC 220 is a network interface card for accessing the network 210. An interface unit 240 modulates and demodulates signals in order to perform data communication with host units (not shown).

If a controller 230 receives a request related to user manual information of a specific function, the controller 230 transmits to the server 130 information on the corresponding image forming apparatus 110 and function that is stored in the memory 250, and receives from the server 130 user manual information according to the corresponding product and function information. A printing unit 260 prints the user manual information of the desired function according to a print command applied from the controller 230.

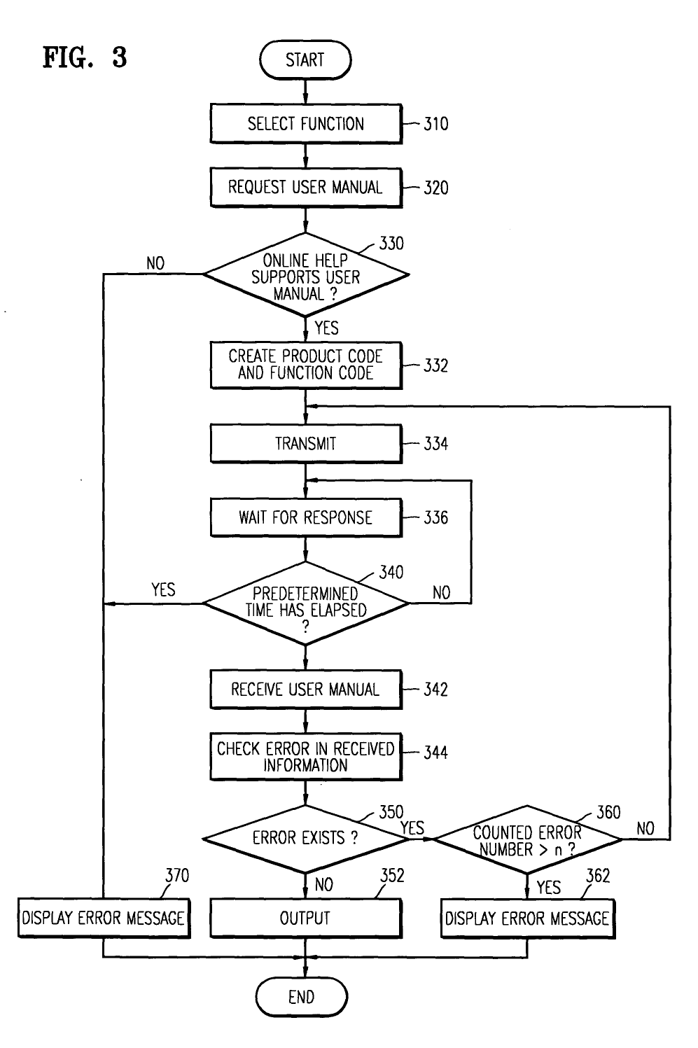

FIG. 3 is a flow chart illustrating a method of providing “HELP”, through the image output apparatus 110, according to the present invention.

Referring to FIG. 3, first, a user selects a function button corresponding to a desired operation function on a screen (operation 310). If the corresponding function button is pressed, user manual information of the corresponding function is requested (operation 320).

If the user manual information is requested, it is checked whether online “HELP” supports the selected function (operation 330). If online HELP does not support the selected function, an error message is displayed (operation 370). On the other hand, if online HELP supports the selected function, product codes, function codes selected by the user, a network address of the image forming apparatus 110, and product information corresponding to an output data format supported by the image forming apparatus 110, are created (operation 332).

Successively, the created product codes, function codes, product information, etc., are transmitted to the server 130 from the image forming apparatus 110, and then receipt of a completion response from the server 130 is awaited (operation 336). At this time, if the receipt of the completion response from the server 130 is not received in a predetermined time (operation 340), an error is considered to have been generated in the network or server, and accordingly an error message is displayed (operation 370).

Successively, if the receipt of the completion response from the server 130 is received in the predetermined time (operation 340), user manual information is received from the server 130 (operation 342).

Then, it is checked whether an error exists in the user manual information is checked (operation 344). If no error exists (operation 350), the received user manual information is output (operation 352).

On the other hand, if an error exists in the received user manual information, the number of errors is counted ((operation step 360). If the counted number is above a predetermined number (n) (operation 360), an error message is displayed on the screen (operation 362). If the counted number is below the predetermined number (n), a request related to user manual information is retransmitted to the server 130.

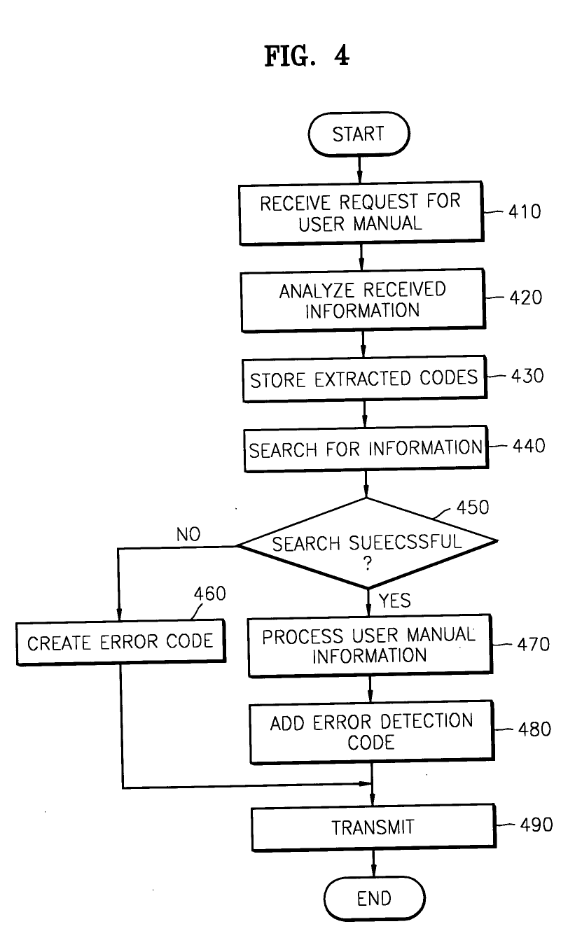

FIG. 4 is a flow chart illustrating a method of providing “HELP”, through the server 130, according to the present invention.

Referring to FIG. 4, first, a request related to user manual information is received from the image output apparatus 110 (operation 410). Successively, the received information is analyzed to extract product codes, function codes, and a network address of the image forming apparatus 110 (operation 420). Then, the extracted product codes, function codes, network address of the image forming apparatus 110, are stored in the memory (not shown) (operation 430). Successively, user manual information of a desired function of the corresponding image forming apparatus 110 is searched for in the database on the basis of the product codes and function codes (operation 440).

Then, it is checked whether the information search is a success (operation 450). Here, if no user manual information exists in the database, an error code is created (operation 460) and transmitted to the image output apparatus 110 requesting the user manual (operation 490). If the user manual information is found in the database, the user manual information is converted into an output data format of the image output apparatus 110 requesting the user manual (operation 480), wherein the output data format of the image output apparatus 110 is a data type capable of being output by the image output apparatus 110. The data may be represented as HTML (HyperText Markup Language), PDF (Portable Document Format), PCL (Printer Command Language), POST SCRIPT, etc., according to the type of image output apparatus 110 requesting the user manual and the data format supported by the image output apparatus 110.

Thereafter, an error detection code is added to the user manual information so that an error capable of being generated in the midst of transmission can be detected (operation 480).

Then, the user manual information is transmitted to the image output apparatus 110 requesting the user manual (operation 490).

The above-described preferred embodiments may be embodied as computer programs and may also be embodied in a general-purpose digital computer to execute the computer programs using a computer readable medium. The computer readable medium includes storage media such as magnetic storage media (e.g., ROM's, floppy discs, hard discs, etc.), optically readable media (e.g., CDROMs, DVDs, etc.), and carrier waves (transmissions over the Internet). The present invention may be embodied in a computer readable medium having a computer readable program code unit embodied therein to cause a number of computer systems connected via a network to effect distributed processing.

As described above, according to the present invention, a user can directly select the user's desired function and view a user manual of the corresponding function on a screen, thereby easily and quickly obtaining the user's desired information. Further, the user can obtain the user's desired function via a network even in a situation where no user manual can be provided or exists. Also, a manufacturer can provide speedy service to a user, obtain additional information, such as frequency of use, function difficulty level, user manual quality, related to various functions of respective image forming apparatues, on the basis of information requested by the user, and efficiently achieve image forming apparatus 110 development or performance improvement, etc., on the basis of such information. Also, since the manufacturer can sufficiently obtain information requested by the user, the number of service requests from users, such as service calls can be reduced, thereby resulting in a reduction in costs.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing a user manual, in an image output apparatus connected to a server to provide a user manual via a network, the method comprising:
receiving a request related to the user manual corresponding to a predetermined operation function of the image output apparatus;
creating product and function codes of the image output apparatus based on the requested information related to the user manual;
transmitting the created product and function codes to the server to provide the user manual via the network; and
receiving user manual information corresponding to the transmitted product and function codes from the server and outputting the user manual information in a predetermined format.

2. The method of claim 1, further comprising:
transmitting to the server the product and function codes with a network address of the image output apparatus and data format information supported by the image output apparatus.

3. The method of claim 1, further comprising:
if the request related to the user manual corresponding to the predetermined operation function of the image output apparatus is received, checking whether the operation function is included in the user manual information; and
if the operation function is not included in the user manual information, outputting an error message.

4. The method of claim 1, further comprising:
if the user manual information is received from the server, checking whether an error exists in the user manual information; and
if the error is detected, retransmitting the request related to the user manual information to the server.

5. A method of providing a user manual of an image forming apparatus, through a server connected via a network, the method comprising:
if a request related to user manual information is received from an image output apparatus via the network, receiving product and function codes of the image forming apparatus;
searching for the user manual information corresponding to the received product and function codes; and
converting the searched user manual information into a predetermined data format and outputting the converted user manual information to the image output apparatus.

6. The method of claim 5, wherein the data format is determined according to a type of the image output apparatus requesting the user manual information and a data format supported by the image output apparatus.

7. The method of claim 5, further comprising:
adding an error detection code to the user manual information when outputting the user manual information.

8. An image output apparatus connected with a server to provide a user manual via a network, the image output apparatus comprising:
a memory which stores product and function codes of the image output apparatus; and
a controller which receives a request of user manual information of a predetermined function, transmits to the server corresponding product and function codes stored in the memory, and receives user manual information corresponding to the product and function codes from the server so as to output the user manual information.

9. A computer readable medium having a computer readable code embodied therein to provide a user manual in an image output apparatus connected to a server via a network according to a method, the method comprising:
receiving a request related to the user manual corresponding to a predetermined operation function of the image output apparatus;
creating product and function codes of the image output apparatus based on the requested information related to the user manual;
transmitting the created product and function codes to the server to provide the user manual via the network; and
receiving user manual information corresponding to the transmitted product and function codes from the server and outputting the user manual information in a predetermined format.

10. The method according to claim 9, further comprising:
considering an error to have been generated in the network or the server, if the receiving does not occur in a predetermined time; and
displaying an error message corresponding to the error generated in the network or the server.

11. The method according to claim 9, further comprising:
checking whether an error exists in the user manual information if the request related to the user manual information is received in a predetermined time.

12. The method according to claim 11, further comprising outputting the user manual information if no error exists.

13. The method according to claim 11, further comprising:
counting the errors in the received user manual information if an error exists;
displaying an error message, if the counted number of errors exceeds a predetermined number; and
requesting the user manual information to be retransmitted, if the counted number of errors is less than a predetermined number.

14. A computer readable medium having a computer readable code embodied therein to provide a user manual of an image forming apparatus, through a server connected via a network, according to a method, the method comprising:
receiving product and function codes of the image forming apparatus, if a request for user manual information is received from an image output apparatus via the network;
searching out the user manual information corresponding to the received product and function codes; and
converting the searched user manual information into a predetermined data format and outputting the converted user manual information to the image output apparatus.

15. The method according to claim 14, wherein the operation of converting the searched user manual information into a predetermined data format is determined according to a type of the image output apparatus requesting the user manual information and a data format supported by the image output apparatus.

16. The method according to claim 14, further comprising:
adding an error detection code to the user manual information when outputting the user manual information.

17. An image output apparatus connected with a server to provide a user manual via a network, the image output apparatus comprising:
a memory to store information related to various functions, a network address of the image output apparatus, and product information of an output data format supported by the apparatus;
a network interface card to access the network;
an interface unit to modulate and demodulate a signal to perform data communication via the network;
a controller to receive a request related to user manual information of a specific function, to transmit to the server the information stored in the memory, and receive from the server user manual information according to the product information; and
a printing unit to print the user manual information of the desired function according to a print command from the controller.

18. The image output apparatus according to claim 17, wherein if the image output apparatus receives the request related to the user manual information of the specific function from the user, the image output apparatus requests product codes and function codes from the server via the network and then receives user manual information transmitted from the server to output the user manual information.

19. The image output apparatus according to claim 18, further comprising a plurality of respective apparatuses connected to the server, wherein the server stores manual information corresponding to the respective apparatuses.

20. The image output apparatus according to claim 19, wherein the server analyzes the corresponding product codes and function codes of the image output apparatus and transmits the user manual information to the user.

21. A computer readable medium having a computer readable code embodied therein to provide a user manual in an image output apparatus, having a memory, connected to a server via a network according to a method, the method comprising:
receiving a request related to the user manual corresponding to a predetermined operation function of the image output apparatus;
retrieving product and function codes of the image output apparatus based on the requested information, from the memory of the image output apparatus, related to the user manual;
transmitting the created product and function codes to the server to provide the user manual via the network; and
receiving user manual information corresponding to the transmitted product and function codes from the server and outputting the user manual information in a predetermined format.

22. The method according to claim 21, further comprising:
considering an error to have been generated in the network or the server, if the receiving does not occur in a predetermined time; and
displaying an error message corresponding to the error generated in the network or the server.

23. The method according to claim 21, further comprising:
checking whether an error exists in the user manual information if the request related to the user manual information is received in a predetermined time.

24. The method according to claim 23, further comprising outputting the user manual information if no error exists.

25. The method according to claim 23, further comprising:
counting the errors in the received user manual information if an error exists;
displaying an error message, if the counted number of errors exceeds a predetermined number; and
requesting the user manual information to be retransmitted, if the counted number of errors is less than a predetermined number.
